(19) United States
(12) Patent Application Publication
(10) Pub. No.: US 2013/0138240 A1
(43) Pub. Date: May 30, 2013

(54) DISPLAY CONTROL APPARATUS, SEWING MACHINE, AND NON-TRANSITORY COMPUTER-READABLE MEDIUM STORING SEWING MACHINE CONTROL PROGRAM

(71) Applicants: Takafumi NAKA, Ama-shi (JP); Tomoko SHIKAI, Nagoya-shi (JP)

(72) Inventors: Takafumi NAKA, Ama-shi (JP); Tomoko SHIKAI, Nagoya-shi (JP)

(73) Assignee: BROTHER KOGYO KABUSHIKI KAISHA, Nagoya-shi (JP)

(21) Appl. No.: 13/604,961

(22) Filed: Sep. 6, 2012

(30) Foreign Application Priority Data
Nov. 29, 2011 (JP) 2011-260529

(51) Int. Cl. D05B 19/12; G09G 5/00

(52) U.S. Cl. 700/137; 112/470.04; 345/660

(57) ABSTRACT

A display control apparatus includes a display control portion that is configured to cause a display portion to display a first display area and a second display area, the display portion being configured to display an image, the first display area being displayed adjacent to the second display area, the first display area being an area that displays first information that includes information that pertains to sewing, and the second display area being an area that displays second information that includes information that pertains to sewing and that is different from the first information, and a size change portion that is configured to change a size of at least one of the first display area and the second display area that are displayed on the display portion by the display control portion.

### CROSS-REFERENCE TO RELATED APPLICATION

This application claims priority to Japanese Patent Application No. 2011-260529, filed Nov. 29, 2011, the content of which is hereby incorporated herein by reference.

### BACKGROUND

The present disclosure relates to a display control apparatus and a sewing machine that are capable of displaying information that pertains to sewing, and to a non-transitory computer-readable medium that stores a sewing machine control program.

A display device is known on which may be displayed a plurality of information items that pertain to sewing, and a sewing machine that includes the display device is also known. For example, a sewing machine is known in which a stitch type selection screen, which is an item display area, may be displayed on a liquid crystal display, along with an area for displaying and setting a swing width for a zigzag stitch type, an area for displaying and setting a stitch length for a stitch type, an area for displaying and setting a thread tension for a stitch type, and various types of input selection keys. Moreover, twenty keys for utility stitches may be displayed on the stitch type selection screen, for example. Various types of information that pertain to sewing may thus be displayed on the liquid crystal display.

### SUMMARY

As functions of the sewing machine increase in number, the number of information items that pertain to sewing may become greater. Therefore, if all of the information items are displayed on the liquid crystal display, the screen may become confusing and more difficult to recognize visually.

Embodiments of the broad principles derived herein provide a display control apparatus, a sewing machine, and a non-transitory computer-readable medium that stores a sewing machine control program that make it possible to present more information items to a user while ensuring that the screen can be recognized visually.

Embodiments provide a display control apparatus that includes a display control portion and a size change portion. The display control portion is configured to cause a display portion to display a first display area and a second display area. The display portion is configured to display an image. The first display area is displayed adjacent to the second display area. The first display area is an area that displays first information that includes information that pertains to sewing. The second display area is an area that displays second information that includes information that pertains to sewing and that is different from the first information. The size change portion is configured to change a size of at least one of the first display area and the second display area that are displayed on the display portion by the display control portion.

Embodiments also provide a sewing machine that includes a display portion, a display control portion, and a size change portion. The display portion is configured to display an image. The display control portion is configured to cause the display portion to display a first display area and a second display area. The first display area is displayed adjacent to the second display area. The first display area is an area that displays first information that includes information that pertains to sewing. The second display area is an area that displays second information that includes information that pertains to sewing and that is different from the first information. The size change portion is configured to change a size of at least one of the first display area and the second display area that are displayed on the display portion by the display control portion.

Embodiments further provide a non-transitory computer-readable medium storing a control program executable on a sewing machine. The program includes instructions that cause the sewing machine to perform the step of causing a display portion to display a first display area and a second display area. The display portion is configured to display an image. The first display area is displayed adjacent to the second display area. The first display area is an area that displays first information that includes information that pertains to sewing. The second display area is an area that displays second information that includes information that pertains to sewing and that is different from the first information. The program also includes instructions that cause the sewing machine to perform the step of changing a size of at least one of the first display area and the second display area that are displayed on the display portion.

### BRIEF DESCRIPTION OF THE DRAWINGS

Embodiments will be described below in detail with reference to the accompanying drawings in which:

FIG. 1 is a figure in which a sewing machine with a cover that has been opened is seen obliquely from the front and above;

FIG. 2 is a block diagram of an electrical configuration of the sewing machine;

FIG. 3 is an example of an image that is displayed on a liquid crystal display;

FIG. 4 is an example of the screen in a state in which a stitch type has been selected;

FIG. 5 is an example of the screen in a state in which the display of the selected stitch type that is shown in FIG. 4 has been inverted left-to-right;

FIG. 6 is an example of the screen in a state in which a second display area in FIG. 5 has been changed to a large area state;

FIG. 7 is an example of the screen in a state in which the size of a stitch type pattern in a selected stitch type display that is shown in FIG. 6 has been made larger;

FIG. 8 is a flowchart that shows main processing;

FIG. 9 is an example of the screen in a state in which the second display area that is shown in FIG. 7 has been changed to a small area state; and

FIG. 10 is an example of the screen in a state in which the second display area is displayed adjacent to and above a first display area.

### DETAILED DESCRIPTION

Hereinafter, an embodiment of the present disclosure will be explained with reference to the drawings. The present embodiment is an example of a case in which the present disclosure is applied to a sewing machine that is configured to form a stitch in a work cloth by moving the work cloth in relation to a needle that may move up and down.

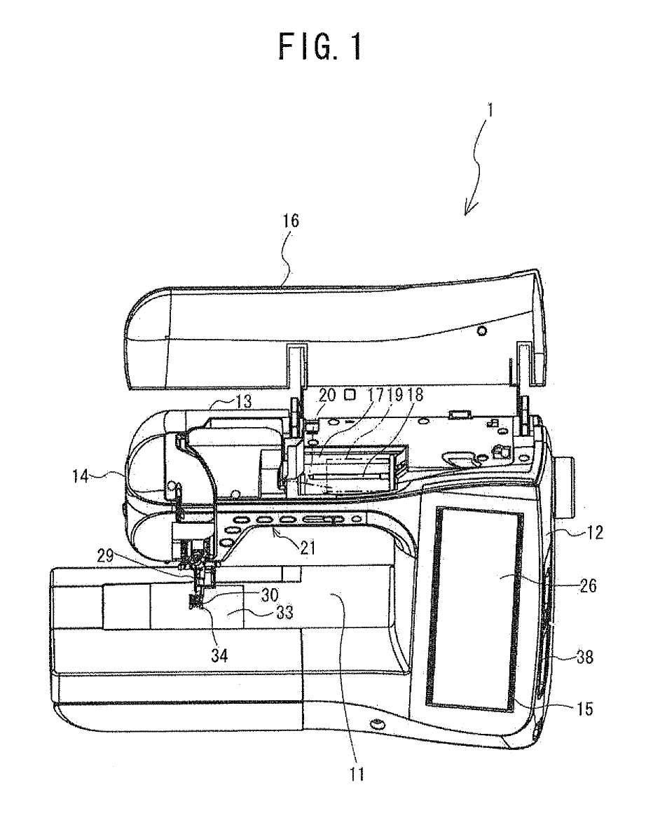

A physical configuration of a sewing machine 1 will be explained with reference to FIG. 1. In the explanation that follows, the near side, the far side, the top side, the bottom side, the left side, and the right side in FIG. 1 are respectively defined as the front side, the rear side, the top side, the bottom side, the left side, and the right side of the sewing machine 1. That is, a face on which a switch cluster 21 (described below) is provided is a front face of the sewing machine 1. A longitudinal direction of a bed 11 and an arm 13 is the left-right direction of the sewing machine 1. A side on which a pillar 12 is provided is the right side of the sewing machine 1. The direction in which the pillar 12 extends is the up-down direction of the sewing machine 1.

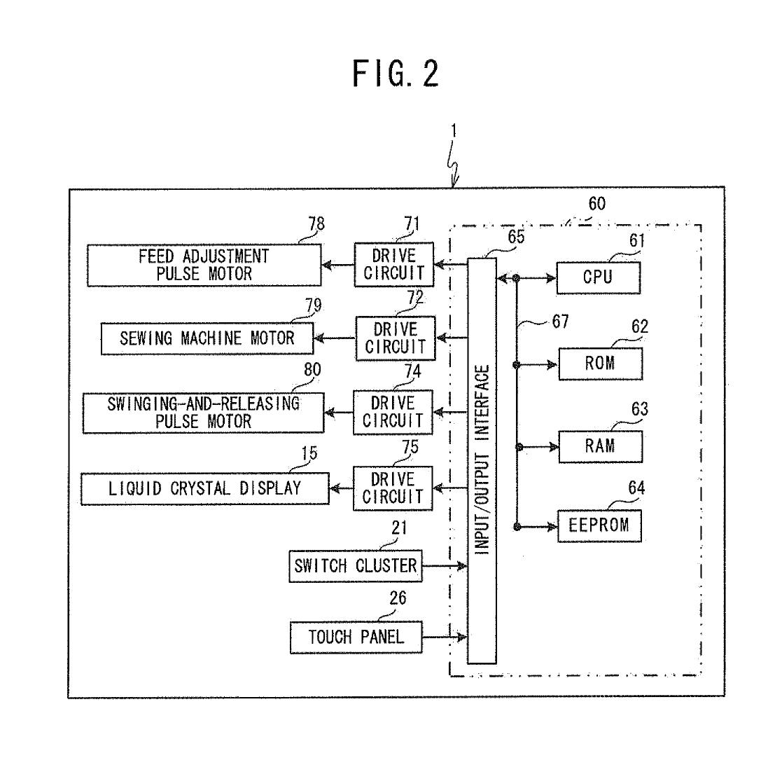

As shown in FIG. 1, the sewing machine 1 includes a bed 11, a pillar 12, an arm 13, and a head 14. The bed 11 extends in the left-right direction. The pillar 12 extends upward from the right end of the bed 11. The arm 13 extends to the left from the upper end of the pillar 12. The head 14 is provided in the left end portion of the arm 13. The bed 11 is provided with a needle plate 33, a feed dog 34, a cloth feed mechanism (not shown in the drawings), a feed adjustment pulse motor 78 (refer to FIG. 2), and a shuttle mechanism (not shown in the drawings). The needle plate 33 is provided on the top face of the bed 11. The feed dog 34 may feed a work cloth (not shown in the drawings) to be sewn by a specified feed distance. The cloth feed mechanism may drive the feed dog 34. The feed adjustment pulse motor 78 may adjust the feed distance. The head 14 is provided with a needle bar mechanism (not shown in the drawings), a swinging-and-releasing pulse motor 80 (refer to FIG. 2), and a thread take-up lever mechanism (not shown in the drawings). The needle bar mechanism may drive a needle bar (not shown in the drawings), to which a needle 29 may be attached, in the up-down direction. The swinging-and-releasing pulse motor 80 may swing the needle to the left and to the right.

A liquid crystal display 15 that has a vertically rectangular shape is provided on the front face of the pillar 12. Keys for executing various types of functions that are necessary for sewing operations, various types of messages, various stitch types, and the like may be displayed on the liquid crystal display 15.

A transparent touch panel 26 is provided on the surface (the front face) of the liquid crystal display 15. Therefore, by using a finger or a special touch pen to touch a position on the touch panel 26 that correspond to the various types of keys and the like on the screen that is displayed on the liquid crystal display 15, a user can, for example, select a stitch type to be sewn, make various types of settings for the selected stitch type, and the like. Hereinafter, the operation of using a finger or the special touch pen to touch a position on the touch panel 26 will be referred to as a panel operation.

A connector 38, to which an external device such as a memory card or the like (not shown in the drawings) can be connected, is provided on the right side face of the pillar 12. Through the connector 38, stitch type data and various types of programs can be loaded into the sewing machine 1 from the external device and can be output from the sewing machine 1 to the outside.

A cover 16 to be opened and closed is attached to the top of the arm 13. The cover 16 is provided in the longitudinal direction of the arm 13. The cover 16 is axially supported at the rear upper edge of the arm 13 such that the cover 16 may be opened and closed around the right-left directional axis. A thread container portion 17 is provided close to the middle of the top of the arm 13 under the cover 16. The thread container portion 17 is a recessed portion for containing a thread spool 19 that may supply a thread to the sewing machine 1. A spool pin 18, which projects toward the head 14, is disposed on an inner face of the thread container portion 17 on the pillar 12 side. The thread spool 19 may be attached to the spool pin 18 when the spool pin 18 is inserted through an insertion hole (not shown in the drawings) that is formed in the thread spool 19. An upper thread 20 may be supplied from the thread spool 19 to a needle 29 that is attached to the needle bar through a thread guide that includes a tensioner, a thread take-up spring, a thread take-up lever, and the like, which are not shown in the drawings. The tensioner is provided in the head 14 and is configured to adjust the thread tension. The thread take-up lever may be driven reciprocally up and down and may pull the thread up.

A drive shaft (not shown in the drawings) is also provided in the arm 13. The drive shaft extends in the longitudinal direction of the arm 13 and may be rotationally driven by a sewing machine motor 79 (refer to FIG. 2). The needle bar mechanism and the thread take-up lever mechanism may be driven by the rotation of the sewing machine drive shaft.

A switch cluster 21 is provided at the bottom of the front face of the arm 13. The switch cluster includes a sewing start/stop switch, a reverse stitch switch, a needle up-and-down switch, a presser foot elevation switch, an automatic threading switch, and the like.

In addition to the needle bar, the thread take-up lever, the tensioner, and the thread take-up spring, which are described above, the head 14 is provided with an automatic thread guide device, an automatic threading mechanism, and the like, which are not shown in the drawings. A presser bar (not shown in the drawings) is provided to the rear of the needle bar. The presser bar is supported by a sewing machine frame such that the presser bar can be moved up and down. A presser foot 30 may be attached to the lower end of the presser bar. The presser foot 30 may press down on the work cloth.

An electrical configuration of the sewing machine 1 will be explained with reference to FIG. 2. As shown in FIG. 2, a control portion 60 of the sewing machine 1 includes a CPU 61, a ROM 62, a RAM 63, an EEPROM 64, and an input/output interface 65, all of which are connected to one another by a bus 67. ROM 62 may store programs, data, and the like for the CPU 61 to perform processing. EEPROM 64 may store data for a plurality of stitch types for the purpose of enabling the sewing machine 1 to sew the stitch types. In the data for the various stitch types, category numbers, sub-category numbers, stitch type patterns, stitch type names, information on the types of the presser foot 30 for performing the sewing, and the like may be associated with one another. The category numbers are identifiers for categories that are classified according to their uses. EEPROM 64 may also store upper limit values, lower limit values, optimum values, and set values for the stitch length, the thread tension, and the like for the stitch types. RAM 63 may store various types of temporary data.

The switch cluster 21, the touch panel 26, and drive circuits 71, 72, 74, 75 are electrically connected to the input/output interface 65. The drive circuit 71 may drive the feed adjustment pulse motor 78. The drive circuit 72 may drive the sewing machine motor 79. The drive circuit 74 may drive the swinging-and-releasing pulse motor 80. The drive circuit 75 may drive the liquid crystal display 15.

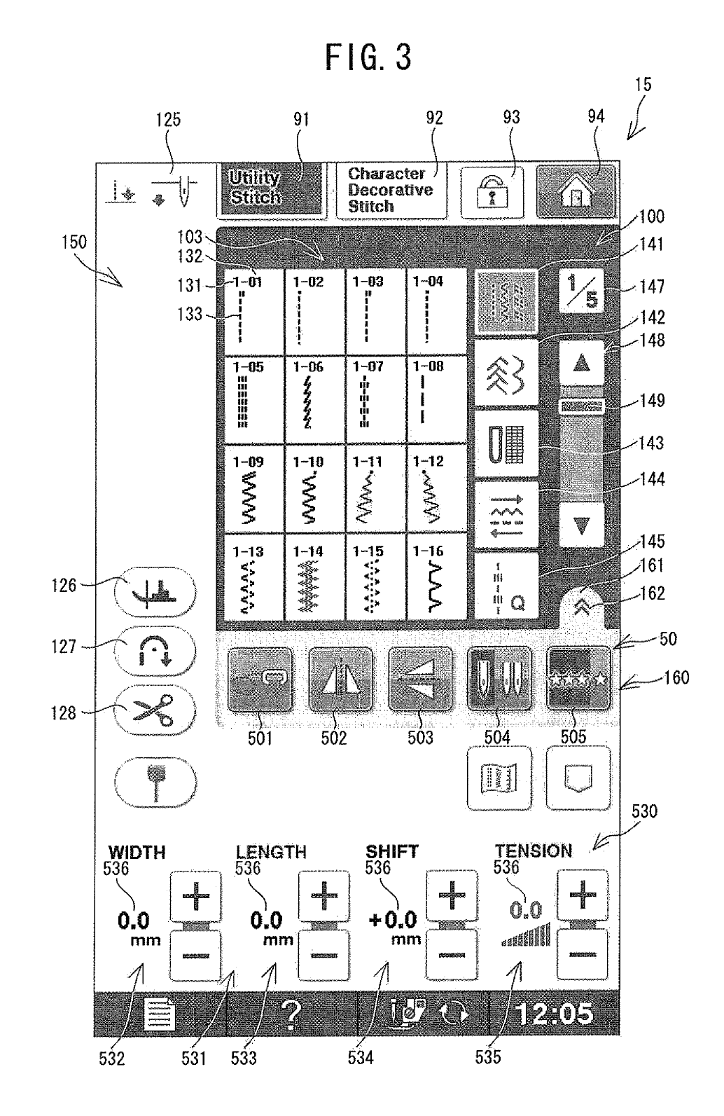

Images that may be displayed on the liquid crystal display 15 will be explained with reference to FIGS. 3 to 7. As shown in FIGS. 3 to 5, a utility stitch key 91, a character decorative stitch key 92, a screen lock key 93, and a home key 94 may be displayed from left to right along the top of the liquid crystal display 15. In a case where the utility stitch key 91 is operated, stitch type selection keys 103 are displayed in a first display area 100 (described below). The stitch type selection keys 103 that are displayed in this case may be used for selecting a utility stitch that is to be formed by the sewing machine 1. The utility stitches are stitch types that may be commonly used in dressmaking, such as a straight stitch, a zigzag stitch, a buttonhole stitch, a quilt stitch, and the like, for example. FIGS. 3 to 7 show states in which the stitch type selection keys 103 for the utility stitches are displayed after the utility stitch key 91 is operated.

In a case where the character decorative stitch key 92 is operated, the stitch type selection keys 103 are displayed in the first display area 100. The stitch type selection keys 103 that are displayed in this case may be used for selecting a character decorative stitch that is to be formed by the sewing machine 1. The character decorative stitches may include, for example, stitch types for hiragana characters, katakana characters, alphabetic characters, and the like, as well as stitch types for decorative patterns. In a case where the screen lock key 93 is operated, the touch panel 26 is locked, such that processing is not performed even if a panel operation is performed. In a case where the home key 94 is operated, a home screen is displayed. The home screen is a screen that is initially displayed when the power supply to the sewing machine 1 is turned on.

The first display area 100 may be displayed below the utility stitch key 91, the character decorative stitch key 92, the screen lock key 93, and the home key 94. The first display area 100 is an area in which first information, which includes information that pertains to sewing, is displayed. The information that pertains to sewing that is included in the first information may include, for example, the stitch type selection keys 103 for the utility stitches, the stitch type selection keys 103 for the character decorative stitches, and the like. The first information may include only information that pertains to sewing. The first information may include information that does not directly pertain to sewing, such as a clock or the like, for example.

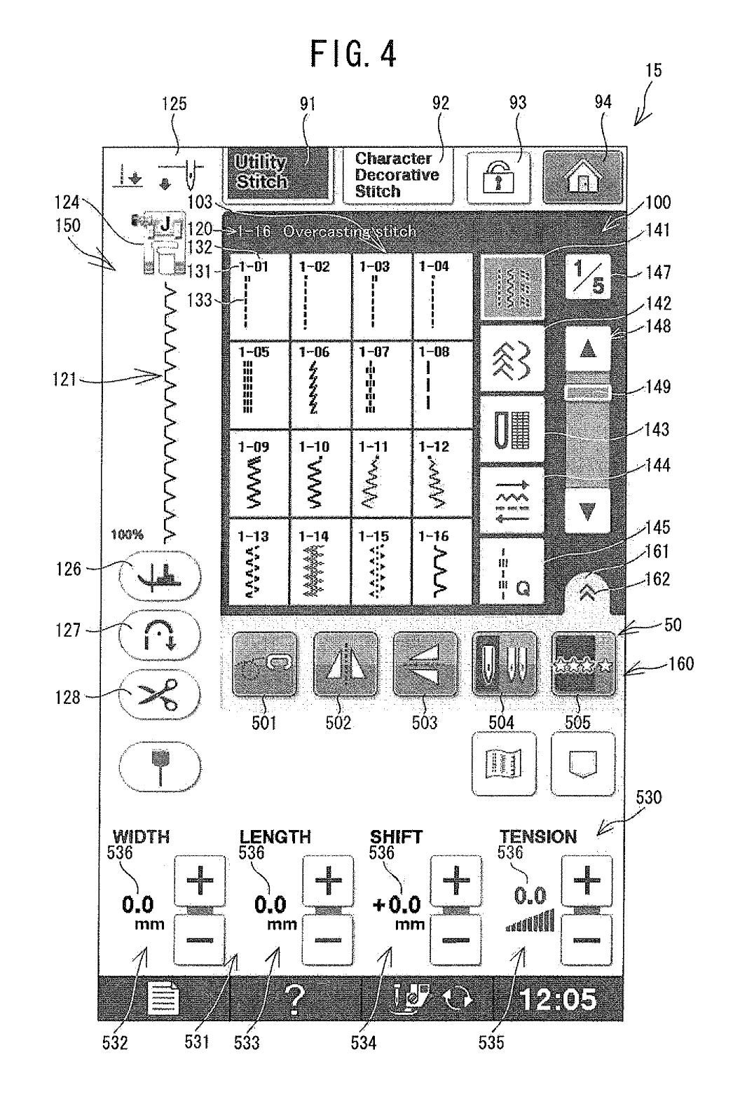

As shown in FIG. 4, the plurality of the stitch type selection keys 103, category selection keys 141 to 145, a category number display 147, and a position display 148 may be displayed as the first information in the first display area 100. The stitch type selection keys 103 may be classified according to the uses of the corresponding stitch types into five categories that are identified by the category numbers 1 to 5. The stitch type selection keys 103 may be displayed in the first display area 100 one category at a time. In the present embodiment, as examples, the category number 1 indicates a group of stitch types that are straight stitches and zigzag stitches. The category number 2 indicates a group of stitch types that are decorative stitch types. The category number 3 indicates a group of stitch types that are buttonhole stitches. The category number 4 indicates a group of stitch types that are transverse stitch types. The category number 5 indicates a group of stitch types that are quilt stitch types. The transverse stitch types are stitch types for which the stitches are formed in the left-right direction by feeding the work cloth to one of the left and the right.

Some {sixteen in FIG. 4) of the plurality of the stitch type selection keys 103 that are classified by the category number 1 may be displayed in the first display area 100 that is shown in FIGS. 3 to 5. A category number 131, a sub-category number 132, and a stitch type pattern 133 may be displayed on each of the stitch type selection keys 103. The category number 131 indicates the name of the category into which the utility stitch is classified. The sub-category number 132 is a number that is assigned to each of the stitch types within the category. The stitch type pattern 133 shows a simplified version of the shape of the stitch type.

Data for the stitch type that corresponds to the stitch type selection key 103 that is selected from among the stitch type selection keys 103 that are displayed in the first display area 100 may be read from the EEPROM 64 and may be stored in the RAM 63. The category number, the sub-category number, and the stitch type name for the selected stitch type may be displayed in a selected stitch type display field 120 above the stitch type selection keys 103 (refer to FIG. 4). In FIG. 4, the stitch type selection key 103 for the category number 1 and the sub-category number 16 has been selected. “1-16 Overcasting stitch” may be displayed in the selected stitch type display field 120 to show the sub-category number and the stitch type name that correspond to the selected stitch type selection key 103.

In addition, the stitch type pattern for the selected utility stitch may be displayed in a selected stitch type display 121 in a selected stitch type display area 150 (refer to FIG. 4). The selected stitch type display area 150 may be provided to the left of the first display area 100. Therefore, the user can easily recognize visually what sort of stitch is to be formed in a case where the selected stitch type is sewn. Other display items that are displayed in the selected stitch type display area 150 will be described below.

The five category selection keys 141 to 145 may be displayed in a vertical array to the right of the plurality of the stitch type selection keys 103 in the first display area 100. The category selection keys 141 to 145 may be used for selecting the category numbers 1 to 5. In a case where any one of the categories is selected by a panel operation, the stitch type selection keys 103 for the stitch types that are included in the selected category are displayed in the first display area 100.

The category number display 147 and the position display 148 may be displayed to the right of the category selection keys 141 to 145. The category number display 147 shows the selected category. In FIGS. 3 to 7, “1/5” is displayed, indicating that, of the total of the five categories, the stitch type selection keys 103 that are classified into the category number 1 are displayed in the first display area 100. The position display 148 indicates the position, among the plurality of the stitch type selection keys 103, of the stitch type selection keys 103 that are displayed in the first display area 100. By performing a panel operation that moves a cursor 149 within the position display 148, the user can move the stitch type selection keys 103 that are displayed up and down. This makes it possible to display the stitch type selection keys 103 that are not displayed in FIGS. 3 to 7.

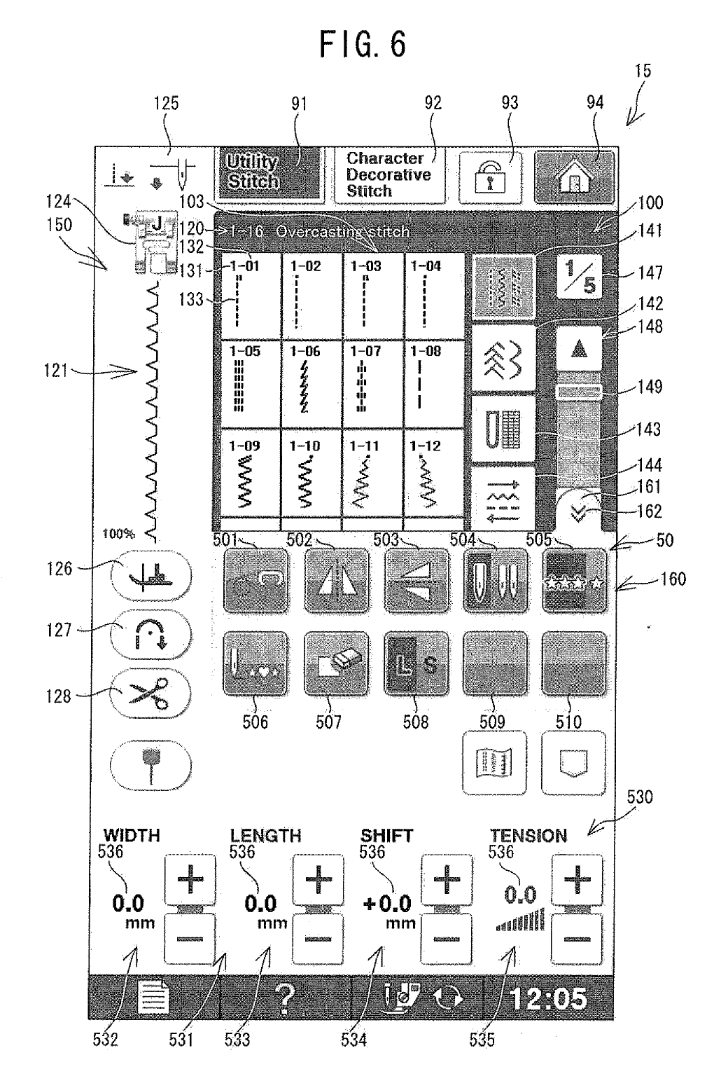

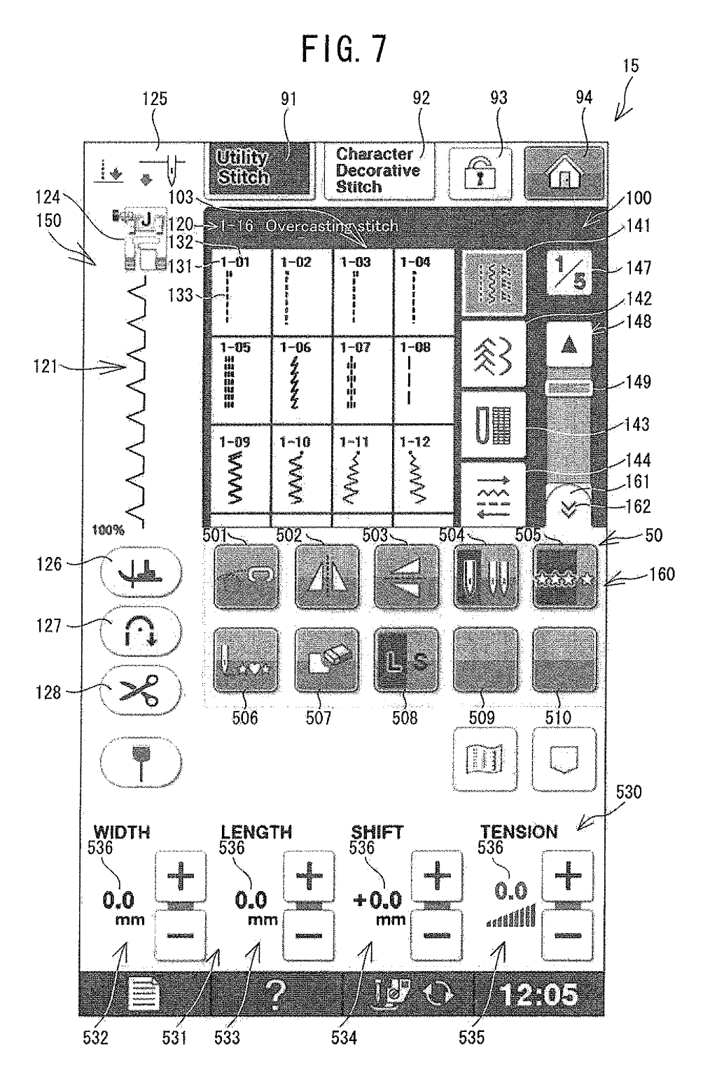

Below the first display area 100, a second display area 160 may be provided that is adjacent to the first display area 100. The second display area 160 is an area that displays second information. The second information may include information that pertains to sewing and that is different from the first information. In the examples that are shown in FIGS. 3 to 7, a plurality of function keys 50 may be displayed in the second display area 160. The function keys 50 may be used for making a setting for a stitch type. Among the function keys 50, function keys 501 to 505 may be displayed in a first row (refer to FIGS. 3 to 7), and function keys 506 to 510 may be displayed in a second row (refer to FIGS. 6 and 7).

Of the plurality of the function keys 50, the function key 501 is a free motion mode key. The function key 501 may be used for making a setting such that the feed dog 34 does not touch the work cloth and the user can move the work cloth freely. The function key 502 is a left-right inversion key. The function key 502 may be used for making a left-right inversion of the stitch type. The function key 503 is a top-bottom inversion key. The function key 503 may be used for making a top-bottom inversion of the stitch type. The function key 504 is a two needles key. The function key 504 may be used for switching settings between a case in which sewing is performed with one needle and a case in which sewing is performed with two needles. The function key 505 is a continuous sewing key. The function key 505 may be used for switching between a case in which a plurality of stitch types are sewn continuously and a case in which the sewing stops after each individual stitch type is sewn.

The function key 506 is a stitch type positioning key. In a case where the function key 506 is operated when the sewing is stopped, the needle drop point can be returned to the starting point for sewing the stitch type during the sewing. The function key 507 is a cancel key. The function key 507 may be used for canceling a stitch type that has been selected. The function key 508 is a size key. The function key 508 may be used for changing the size of the selected stitch type. The function keys 509 and 510 are undefined. New functions can be added to the undefined function keys 509 and 510 by connecting to the connector 38 (refer to FIG. 1) an external device in which are stored data for setting new function keys and storing the data for setting the function keys in the EEPROM 64 of the sewing machine 1, for example. Of the function keys 501 to 510, the function keys 501 to 505 that are displayed in the first row may be set for functions that are used more frequently than the functions for which the function keys 506 to 510 that are displayed in the second row are set. The second information may include only information that pertains to sewing. The second information may include information that does not directly pertain to sewing, such as a clock or the like, for example.

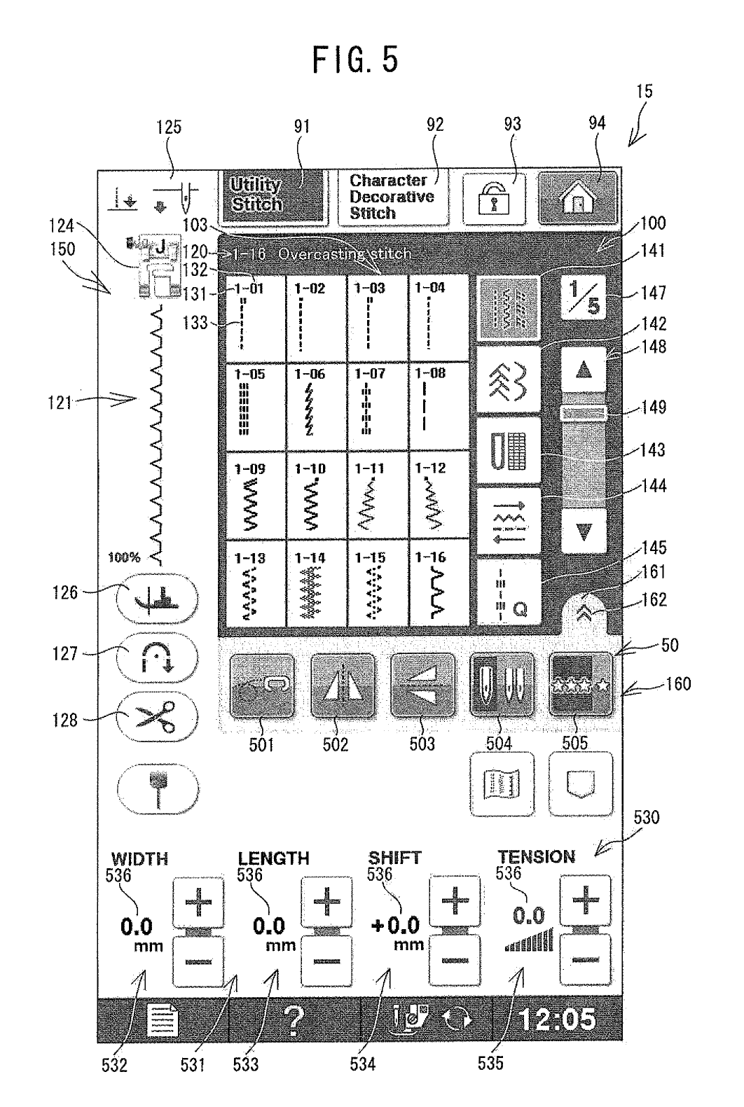

The size of the second display area 160 may be changed by operating a tab 161. For example, in FIG. 5, the function keys 50 in the first row (the function keys 501 to 505) are displayed. In a case where the tab 161 is operated, the size of the second display area 160 is made larger, and the function keys 50 in the second row (the function keys 506 to 510) are also displayed, as shown in FIG. 6. In the explanation that follows, the state in which the size of the second display area 160 is small, as shown in FIGS. 3 to 5, is referred to as the small area state. The state in which the size of the second display area 160 is large, as shown in FIGS. 6 and 7, is referred to as the large area state.

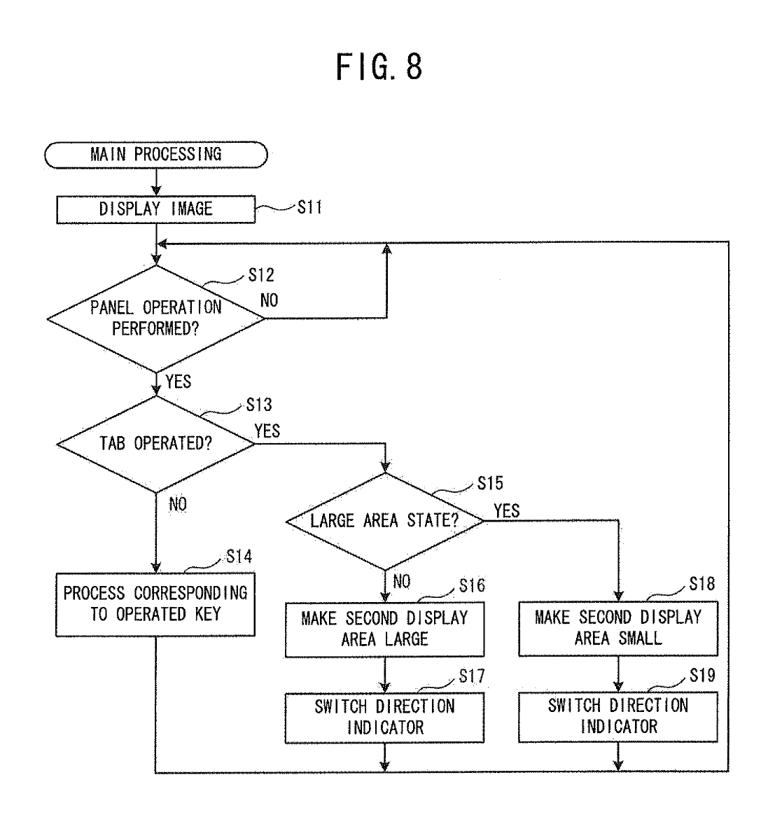

The tab 161 of the second display area 160 is a portion that protrudes from the second display area 160 (upward in the present embodiment) toward the first display area 100 that is adjacent to the second display area 160. More specifically, the tab 161 may be provided in the upper right part of the second display area 160 and may protrude upward. The upper end of the tab 161 may be displayed as having a rounded shape. The size of the second display area 160 may be changed by performing a panel operation such as touching the tab 161, dragging and dropping the tab 161, or the like (refer to Steps S16 and S18 in FIG. 8, described below).

A direction indicator 162 may be displayed within the tab 161. The direction indicator 162 indicates the direction in which the size of the second display area 160 can be changed. For example, in a case where the second display area 160 is in the small area state (refer to FIGS. 3 to 5), the direction indicator 162 indicates an upward direction. In this case, if the tab 161 is operated, the second display area 160 becomes larger in the upward direction and enters the large area state (refer to FIGS. 6 and 7). In a case where the second display area 160 is in the large area state, the direction indicator 162 indicates a downward direction. In this case, if the tab 161 is operated, the second display area 160 becomes smaller in the downward direction and enters the small area state (refer to FIGS. 3 to 5).

The above-described selected stitch type display area 150 will be explained in more detail. As shown in FIG. 4, a presser foot code 124 may be displayed above the selected stitch type display 121 in the selected stitch type display area 150. The presser foot code 124 indicates the presser foot 30 (refer to FIG. 1) that is to be attached in a case where the stitch type that has been selected by a panel operation of one of the stitch type selection keys 103 is sewn. By referencing the presser foot code 124, the user can attach the presser foot 30 that is appropriate for sewing the selected stitch type. A needle setting state 125 may be displayed above the presser foot code 124. The needle setting state 125 indicates what the position of the needle is to be when the operation of the sewing machine 1 stops. In the needle setting state 125 in FIGS. 3 to 7, an arrow points downward. The needle setting state 125 thus indicates a setting in which the needle 29 is to be stopped in a state of having pierced the work cloth when the operation stops.

A pivot key 126, an automatic reinforcement stitch key 127, an automatic thread cut key 128, and the like may be displayed in a vertical array below the selected stitch type display 121. The pivot key 126 may be used for making a pivot setting. In a case where a pivot setting is made and sewing is stopped, the sewing machine 1 stops sewing with the needle 29 in a lowered state. Then the presser foot 30 may automatically rise. The user may rotate the work cloth using the needle 29 as a pivot point. The automatic reinforcement stitch key 127 may be used for setting an operation that sews a reinforcement stitch automatically when sewing starts and when sewing is completed. The automatic thread cut key 128 may be used for making a setting such that the upper thread and a lower thread is to be cut automatically when sewing is completed.

An item display area 530 may be provided below the second display area 160. Stitch adjustment keys 531, a shift key 534, and a tension key 535 may be displayed in the item display area 530. The stitch adjustment keys 531 include a width adjustment key 532 and a length adjustment key 533. The width adjustment key 532 may be used for adjusting the zigzag swing width for the stitch type that has been selected by one of the stitch type selection keys 103. The length adjustment key 533 may be used for adjusting the stitch length for the selected stitch type. The shift key 534 may be used for moving the stitch position to the left and to the right. The tension key 535 may be used for adjusting the thread tension. Individual setting values can be increased and decreased, and the desired setting values can be adjusted, by operating the individual keys 532 to 535 that are displayed in the item display area 530. The setting values may be displayed in setting value displays 536 to the left of the corresponding keys 532 to 535.

The upper and lower limit values for the swing width and the upper and lower limit values for the stitch length may be respectively set in the range of 0.0 to 7.0 millimeters and the range of 0.0 to 5.0 millimeters in accordance with the stitch type that is selected, and the values may be stored in one of the ROM 62 and the EEPROM 64. The upper and lower limit values that have been stored for the swing width and the stitch length may be read out when various types of processing that involve the swing width and the stitch length are performed, and the values may be stored in the RAM 63 in a state in which the values can be adjusted. It is therefore possible for the swing width and the stitch length for the selected stitch type to be adjusted easily and precisely as the user desires. Accordingly, the stitch type may be sewn using the desired stitches. The setting value for the thread tension may be ordinarily set to an optimum thread tension that is determined for each stitch type. For example, it is possible to adjust the thread tension in a range of 0.0 to 9.0.

Main processing will be explained with reference to the flowchart in FIG. 8. The program for performing the main processing may be stored in the ROM 62 (refer to FIG. 2) and may be executed by the CPU 61 of the sewing machine 1. The main processing is started when the power supply to the sewing machine 1 is turned on. As shown in FIG. 8, in the main processing, first, an image is displayed on the liquid crystal display 15 (Step S11). The image that is displayed at Step S11 may be, for example, an image that had been displayed on the liquid crystal display 15 immediately before the power supply to the sewing machine 1 was turned off previously. Information for displaying the image may be stored in the EEPROM 64. At Step S11, the information that is stored in the EEPROM 64 for displaying the image is read out and stored in the RAM 63, and the image is displayed. In the present embodiment, as a specific example, the image that is shown in FIG. 3 may be displayed on the liquid crystal display 15. As shown in FIG. 3, at Step S11, the liquid crystal display 15 may displays the first display area 100 and the second display area 160 in a state in which the first display area 100 and the second display area 160 are adjacent to one another. The above-described first information may be displayed in the first display area 100, and the above-described second information may be displayed in the second display area 160. FIG. 3 shows an image of a state in which a stitch type has not been selected.

Next, a determination is made as to whether a panel operation has been performed (Step S12). If a panel operation has not been performed (NO at Step S12), the processing returns to Step S12. If a panel operation has been performed (YES at Step S12), a determination is made as to whether the tab 161 has been operated (Step S13). Specifically, a determination is made as to whether the panel operation that was detected at Step S12 is a panel operation at the location on the touch panel 26 that corresponds to the tab 161 (the location where the tab 161 is positioned on the front face).

In a case where the tab 161 has not been operated (NO at Step S13), processing is performed that corresponds to the key that has been operated (Step S14). For example, a case is considered in which, of the stitch type selection keys 103 in the first display area 100 that is shown in FIG. 3, the stitch type selection key 103 for the sub-category number 1-16 has been operated. In this case, the stitch type data that correspond to the stitch type with the sub-category number 1-16 may be read out from the EEPROM 64 and may be stored in the RAM 63. Then, as shown in FIG. 4, the selected stitch type display 121 may be displayed based on the stitch type pattern that is associated with the stitch type data. In addition, the presser foot code 124 may be displayed based on information about the type of the presser foot 30 that is to be used for performing the sewing. Furthermore, the sub-category number and the stitch type name “1-16 Overcasting stitch” may be displayed in the selected stitch type display field 120. Next, the processing returns to Step S12.

Various types of settings may be made for the stitch type for the selected sub-category number 1-16 by using the function keys 50, the stitch adjustment key 531, the shift key 534, the tension key 535, and the like. For example, in a case where the function key 502 (the left-right inversion key) that is displayed in the second display area 160 has been operated (YES at Step S12; NO at Step S13), the selected stitch type display 121 is inverted left to right and is changed from the state that is shown in FIG. 4 to the state that is shown in FIG. 5 (Step S14). In a case where the user desires to display more of the function keys 50 in the second display area 160 and make settings for the stitch type, the user may operate the tab 161 to put the second display area 160 into the large area state (refer to FIG. 6).

In a case where, at Step S13, the location on the touch panel 26 that corresponds to the tab 161 has been operated (YES at Step S13), a determination is made as to whether the second display area 160 is in the large area state (refer to FIGS. 6 and 7) (Step S15). For example, in a case where the second display area 160 is in the small area state, as shown in FIG. 5, a determination is made that the second display area 160 is not in the large area state (NO at Step S15). Accordingly, the size of the second display area 160 is changed such that the second display area 160 is displayed as large (Step S16). The second display area 160 is thus changed from the small area state (refer to FIG. 5) to the large area state (refer to FIG. 6). Because the second display area 160 becomes larger, the sewing machine 1 may present the additional second information (the function keys 50 in the present embodiment) to the user. At Step S16, the second display area 160 gradually becomes larger in the upward direction from the small area state (refer to FIG. 5) until it reaches the large area state (refer to FIG. 6). Moreover, as the second display area 160 becomes larger, the first display area 100 that is adjacent to the second display area 160 becomes smaller (refer to FIGS. 5 and 6). Therefore, the user may visually recognize that the second information (the function keys 50) in the second display area 160 has been pulled out in front of the first display area 100.

Next, at approximately the same time as Step 516, the direction indicator 162 of the tab 161 is switched to the direction in which the size of the second display area 160 can be changed the next time (Step S17). Specifically, as shown in FIG. 6, the direction indicator 162 may point in the downward direction, that is, toward the direction in which the change can be made from the large area state (refer to FIGS. 6 and 7) to the small area state (refer to FIGS. 3 to 5). Next, the processing returns to Step S12.

In the case of the specific example, the second display area 160 enters the large area state, as shown in FIG. 6, and the function keys 506 to 510 may be displayed in the second row (Step S16). Thus the function keys 506 to 510, which were not displayed in the small area state (refer to FIG. 5), may become operable. For example, in a case where the function key 508 (the size key) has been operated by the user (YES at Step S12; NO at Step S13), the stitch type pattern in the selected stitch type display 121 becomes larger (Step S14), as shown in FIG. 7. A case is considered in which, in this state, the sewing start/stop switch in the switch cluster 21 (refer to FIGS. 1 and 2) is operated. In that case, the stitch type with the sub-category number 1-16, which has been inverted left to right and enlarged, in the same manner as the stitch type pattern that is displayed in the selected stitch type display 121, may be sewn in the work cloth, although this is not shown in the flowchart in FIG. 8.

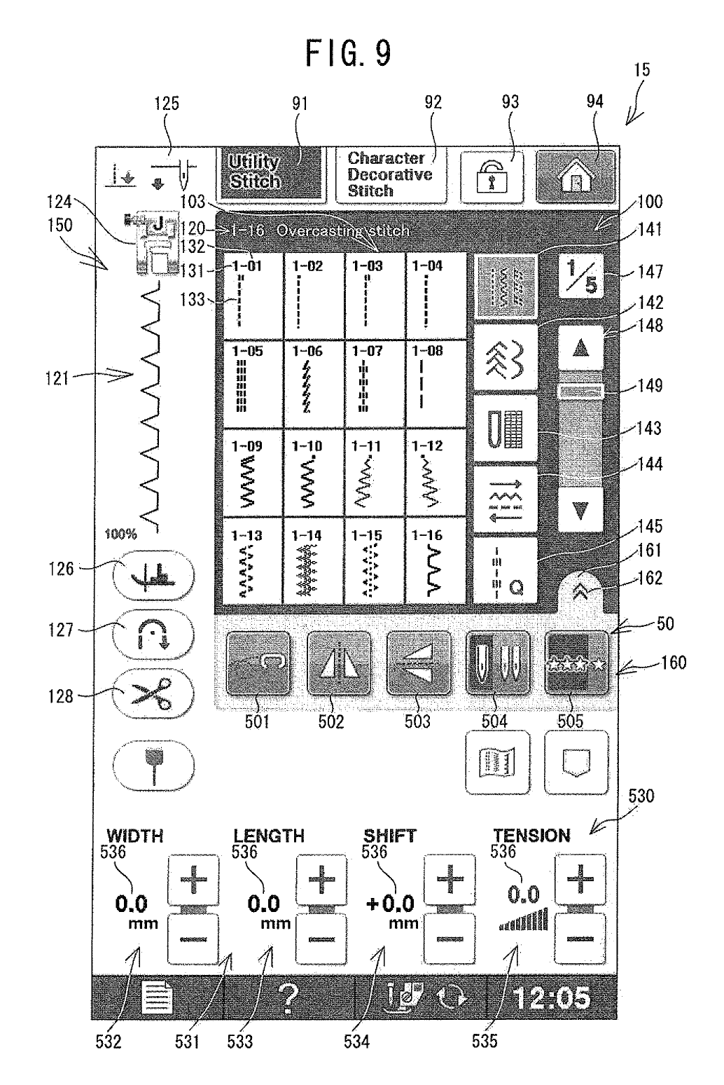

In a case where it has been determined at Step S15 that the second display area 160 is in the large area state (YES at Step S15), the size of the second display area 160 is changed, and the second display area 160 is displayed as small (Step S18). The second display area 160 is thus changed from the large area state (refer to FIG. 7) to the small area state (refer to FIG. 9). At Step S18, the second display area 160 gradually becomes smaller in the downward direction from the large area state (refer to FIG. 7) until the second display area 160 reaches the small area state (refer to FIG. 9). Moreover, as the second display area 160 becomes smaller, the first display area 100 that is adjacent to the second display area 160 becomes larger (refer to FIGS. 7 and 9). Therefore, the user may visually recognize that the second information that had been pulled out and displayed in the second display area 160 has been stowed in the downward direction. Furthermore, because the first display area 100 becomes larger, the first information that is displayed in the first display area 100 may be increased. That is, the sewing machine 1 may present more of the first information to the user than it can when the second display area 160 is in the large area state.

Next, at approximately the same time as the processing at Step S18, the direction indicator 162 of the tab 161 is switched to the direction in which the size of the second display area 160 can be changed the next time (Step S19). Specifically, as shown in FIG. 9, the direction indicator 162 may point in the upward direction, that is, toward the direction in which the change can be made from the small area state (refer to FIGS. 3 to 5 and 9) to the large area state (refer to FIGS. 6 and 7). Next, the processing returns to Step S12.

The main processing according to the present embodiment is performed as described above. The size of the liquid crystal display 15 is limited. Accordingly, if too much information is displayed on the liquid crystal display 15, it may be difficult to visually recognize the image. In the present embodiment, the size of the second display area 160 can be changed. Therefore, it is best for the number of items of the first information (the stitch type selection keys 103 and the like) and the second information (the function keys 501 to 505) that are displayed in the first and second display areas 100, 160 to be limited to a number that makes it possible to visually recognize the image (refer to FIGS. 3 to 5). Then the size of the second display area 160 may be enlarged when it is necessary to do so. That makes it possible to display and present to the user the information (the function keys 506 to 510) that has not been displayed up to that point (refer to FIGS. 6 and 7). In other words, in the present embodiment, a greater amount of information can be presented to the user while assuring the visual comprehensibility of the image.

The user may change the size of the second display area 160 by operating the touch panel 26. That is, because the user uses the touch panel 26, the user can change the size of the second display area 160 intuitively by operating the tab 161 in the image that is displayed on the liquid crystal display 15. Because the panel operation can be performed intuitively, the convenience for the user may be improved.

The user may change the size of the second display area 160 by performing a panel operation on the location on the touch panel 26 that corresponds to the tab 161. Because the tab 161 is displayed on the liquid crystal display 15, it may be easy for the user to recognize the location of the operation portion (that is, the tab 161) that changes the size of the second display area 160. This may improve the operability in a case where the user changes the size of the second display area 160.

The tab 161 is a portion that protrudes toward the first display area 100 from the second display area 160. Therefore, the tab 161 may be made conspicuous on the screen that is displayed on the liquid crystal display 15. That makes it easier for the user to recognize the position of the tab 161. The operability in a case where the user changes the size of the second display area 160 may therefore be further improved.

The direction indicator 162 that indicates the direction in which the size of the second display area 160 can be changed is displayed within the tab 161. Therefore, in a case where the user operates the tab 161, the user can easily recognize the direction in which the size of the second display area 160 can be changed. That may improve the convenience for the user.

In the present embodiment, the tab 161 protrudes from the second display area 160. Therefore, the shape of the tab 161 may appear to be a shape that resembles an opening that is frequently touched in ordinary daily life, such as an opening in the lid of a candy container or the like, for example. When one opens the lid of a candy container by gripping the opening with one's fingers, the forms of the candy inside may become visible. In the present embodiment, the tab 161 is shaped to resemble an opening. Therefore, the user may easily recognize that the form of the information that has not been displayed has become visible (is displayed) if the user operates the tab 161 in the same manner as when opening the lid of a candy container. For an elderly user, in particular, it may often be difficult to access various types of information by performing a panel operation on a screen. However, the user may easily recognize that the form of the information that has not been displayed has become visible if the user operates the tab 161. It may therefore be easy for even an elderly user to operate the tab 161.

Even in a case where the second display area 160 is in the small area state, as shown in FIGS. 3 to 5, the first row of the function keys 50 may be displayed. That is, a portion of the plurality of the function keys 50 may be displayed in the second display area 160. Therefore, the user may easily recognize the area in which the second display area 160 displays the function keys 50. The tab 161 is also provided. Therefore, the user may easily recognize that even more of the function keys 50 can be displayed by operating the tab 161. This makes it possible to smoothly select and make settings for the stitch type that is to be sewn.

The first information that is displayed in the first display area 100 includes the plurality of the stitch type selection keys 103 for selecting a stitch type that is to be sewn. The second information that is displayed in second display area 160 includes the plurality of the function keys 50 for making settings for the stitch type that is to be sewn. Therefore, the stitch type may be selected by operating one of the stitch type selection keys 103 that are displayed in the first display area 100. The size of the second display area 160 may be changed, and the settings for the stitch type may be made by operating the function keys 50. Therefore, the user may smoothly select and make settings for the stitch type that is to be sewn.

Of the function keys 501 to 510, the function keys 501 to 505 that are displayed in the first row may be set for functions that are used more frequently than the functions for which the function keys 506 to 510 that are displayed in the second row are set. Moreover, the frequently used function keys 501 to 505 in the first row may be displayed even in a case where the second display area 160 is in the small area state (refer to FIGS. 3 to 5). The user may therefore operate the frequently used function keys 501 to 505 in the first row when the second display area 160 is in the small area state. The user may put the second display area 160 into the large area state by operating the tab 161 and to display the function keys 506 to 510 in the second row only in a case where the function keys 506 to 510, which may be used less frequently, is to be operated. This may reduce the frequency with which the tab 161 for changing the second display area 160 between the small area state and the large area state is operated. The user may thus more smoothly select and make settings for the stitch type that is to be sewn.

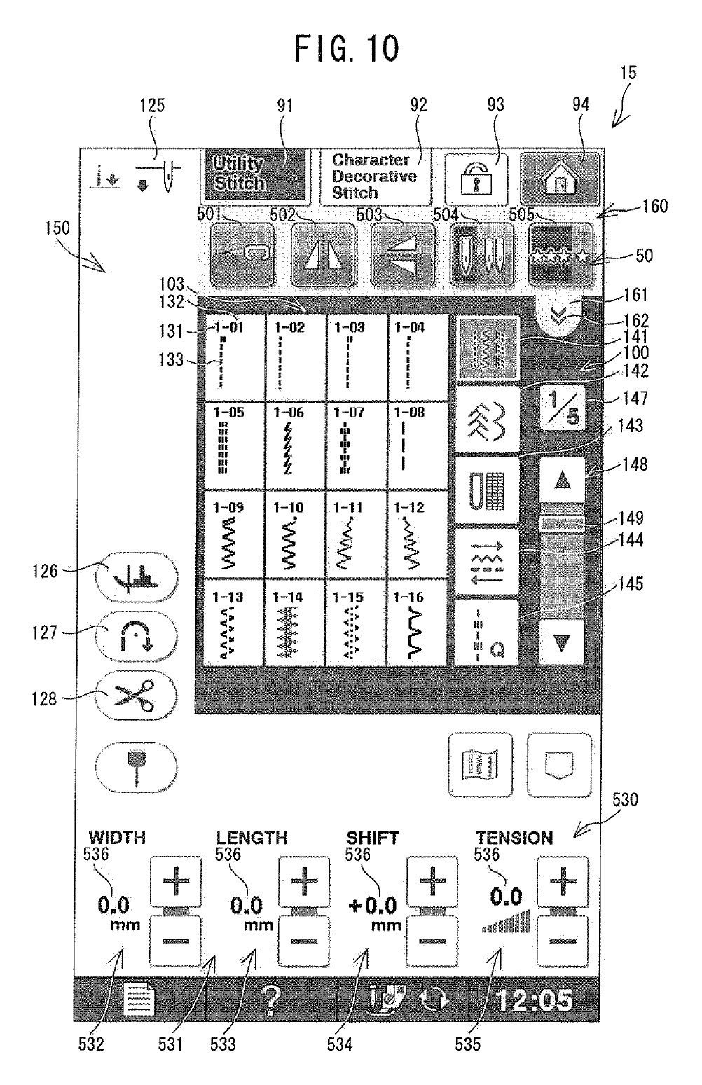

The present disclosure is not limited to the embodiment that is described above, and various types of modifications may be possible. For example, the second display area 160 is displayed adjacent to and below the first display area 100, but the present disclosure is not limited to this example. As shown in FIG. 10, for example, the second display area 160 may be displayed adjacent to and above the first display area 100. The second display area 160 may be displayed adjacent to and to the right or the left of the first display area 100.

In the embodiment that is described above, the size of the second display area 160 may be changed, but the present disclosure is not limited to this example. For example, the screen may be configured such that the size of the first display area 100 can be changed in the same manner as the second display area 160. The screen may be configured such that the sizes of both the first display area 100 and the second display area 160 can be changed. That is, the screen may be configured such that the size of at least one of the first display area 100 and the second display area 160 can be changed. In that case, the user may change the size of whichever one of the first display area 100 and the second display area 160 the user desires to change. That makes it possible to display more of the information that is displayed in the display area that the user desires to change.

In a case where the second display area 160 becomes larger, the first display area 100 becomes smaller, but the present disclosure is not limited to this example. For example, the first display area 100 may slide as the second display area 160 becomes larger.

In a case where the second display area 160 is in the large area state, two rows of the function keys 50 are displayed, but the present disclosure is not limited to this example. For example, when where the second display area 160 is in the large area state, three rows of the function keys 50 may be displayed. In that case, the screen may be configured such that the second display area 160 can be adjusted, by operating the tab 161, to display any desired number of rows from one to three.

The tab 161 protrudes toward the first display area 100 from the second display area 160, but the present disclosure is not limited to this example. For example, the tab 161 may be provided within the second display area 160 such that the tab 161 does not protrude.

The first information that is displayed in the first display area 100 includes the stitch type selection keys 103 and the like, and the second information that is displayed in the second display area 160 includes the function keys 50, but the present disclosure is not limited to this example. As long as the first information and the second information include the information that pertains to sewing, the first information and the second information may also include other information. For example, a camera that is capable of acquiring an image of the work cloth in the vicinity of the presser foot 30 may be provided in the head 14 of the sewing machine 1. The image that the camera has acquired may be displayed in the first display area 100, and keys that perform camera settings, such as keys for enlarging and reducing the image or the like, may be displayed in the second display area 160.

In the embodiment that is described above, an image is displayed on the liquid crystal display 15, but the present disclosure is not limited to this example. For example, the image may be displayed on a different type of display, such as an organic electroluminescence (EL) display or the like.

In the embodiment that is described above, operations such as selecting and making settings for the stitch type are performed using the touch panel 26, but the present disclosure is not limited to this example. For example, a mouse may be connected to the sewing machine 1. The sewing machine 1 may be configured such that operations can be performed by using the mouse to move the cursor on the liquid crystal display 15.

In the embodiment that is described above, the size of the second display area 160 is changed when the tab 161 is operated, but the present disclosure is not limited to this example. For example, the sewing machine 1 may be provided with a mechanical switch. The second display area 160 may be put into the large area state when the switch is turned on and may be put into the small area state when the switch is turned off.

The shape of the tab 161 is not limited to the shape that is shown in the embodiment that is described above. For example, the shape of the tab 161 may be rectangular. The tip of the tab 161 may be triangular. A pattern may be shown on the tab 161. In that case, the pattern may make the tab 161 more noticeable. The user may therefore more easily recognize the location where the tab 161 can be operated.

In the embodiment that is described above, control of the image that is displayed on the liquid crystal display 15 of the sewing machine 1 is performed by the executing of the main processing that is shown in FIG. 8 by the CPU 61 of the sewing machine 1. However, a CPU that is provided in a separate device from the sewing machine 1 may perform the main processing that is shown in FIG. 8. The separate device from the sewing machine 1 may be, for example, a device such as a portable terminal, a personal computer, or the like. The image may be displayed on a separate display from the liquid crystal display 15 of the sewing machine 1. For example, the separate device from the sewing machine 1 may perform the main processing that is described above while the image is displayed on a display that the device includes or on a display that is connected to the device. The edited data for the stitch type may then be transmitted to the sewing machine 1, and the sewing machine 1 may perform the sewing.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A display control apparatus comprising:
a display control portion that is configured to cause a display portion to display a first display area and a second display area, the display portion being configured to display an image, the first display area being displayed adjacent to the second display area, the first display area being an area that displays first information that includes information that pertains to sewing, and the second display area being an area that displays second information that includes information that pertains to sewing and that is different from the first information; and
a size change portion that is configured to change a size of at least one of the first display area and the second display area that are displayed on the display portion by the display control portion.

2. The display control apparatus according to claim 1, wherein
the size change portion, in a case where a command has been input through an input portion to change the size of at least one of the first display area and the second display area, changes the size of the at least one of the first display area and the second display area in accordance with the command.

3. The display control apparatus according to claim 2, wherein
the display control portion is configured to cause the display portion to display a specific portion within the second display area, the specific portion indicating an operation portion for changing the size of the second display area, and
the size change portion, in a case where an operation command for the specific portion has been input through the input portion, changes the size of at least the second display area.

4. The display control apparatus according to claim 3, wherein
the specific portion is a portion that protrudes from the second display area toward the first display area that is adjacent to the second display area.

5. The display control apparatus according to claim 4, further comprising:
a direction display portion that is configured to cause the display portion to display a direction indicator within the specific portion, the direction indicator indicating a direction in which the size of the second display area can be changed,
wherein, in a case where the size of the second display area has been changed by the size change portion, the direction display portion switches the direction indicated by the direction indicator to a direction in which the size of the second display area can be changed the next time.

6. The display control apparatus according to claim 1, wherein
the first information includes a plurality of stitch type selection keys that are used for selecting a stitch type to be sewn, and
the second information includes a plurality of types of function keys that are used for making a setting for the stitch type.

7. The display control apparatus according to claim 2, wherein
the display portion is a liquid crystal display, and
the input portion is a transparent touch panel that is provided on a front face of the liquid crystal display.

8. A sewing machine comprising:
a display portion that is configured to display an image;
a display control portion that is configured to cause the display portion to display a first display area and a second display area, the first display area being displayed adjacent to the second display area, the first display area being an area that displays first information that includes information that pertains to sewing, and the second display area being an area that displays second information that includes information that pertains to sewing and that is different from the first information; and
a size change portion that is configured to change a size of at least one of the first display area and the second display area that are displayed on the display portion by the display control portion.

9. The sewing machine according to claim 8, further comprising:
an input portion through which a command can be input to change the size of at least one of the first display area and the second display area,
wherein the size change portion, in a case where the command has been input through the input portion, changes the size of the at least one of the first display area and the second display area in accordance with the command.

10. The sewing machine according to claim 9, wherein
the display control portion is configured to cause the display portion to display a specific portion within the second display area, the specific portion indicating an operation portion for changing the size of the second display area, and
the size change portion, in a case where an operation command for the specific portion has been input through the input portion, changes the size of at least the second display area.

11. The sewing machine according to claim 10, wherein
the specific portion is a portion that protrudes from the second display area toward the first display area that is adjacent to the second display area.

12. The sewing machine according to claim 11, further comprising:
a direction display portion that is configured to cause the display portion to display a direction indicator within the specific portion, the direction indicator indicating a direction in which the size of the second display area can be changed,
wherein, in a case where the size of the second display area has been changed by the size change portion, the direction display portion switches the direction indicated by the direction indicator to a direction in which the size of the second display area can be changed the next time.

13. The sewing machine according to claim 8, wherein
the first information includes a plurality of stitch type selection keys that are used for selecting a stitch type to be sewn, and
the second information includes a plurality of types of function keys that are used for making a setting for the stitch type.

14. The sewing machine according to claim 9, wherein
the display portion is a liquid crystal display, and
the input portion is a transparent touch panel that is provided on a front face of the liquid crystal display.

15. A non-transitory computer-readable medium storing a control program executable on a sewing machine, the program comprising instructions that cause the sewing machine to perform the steps of:
causing a display portion to display a first display area and a second display area, the display portion being configured to display an image, the first display area being displayed adjacent to the second display area, the first display area being an area that displays first information that includes information that pertains to sewing, and the second display area being an area that displays second information that includes information that pertains to sewing and that is different from the first information; and
changing a size of at least one of the first display area and the second display area that are displayed on the display portion.

16. The non-transitory computer-readable medium according to claim 15, wherein:
the program further comprises instructions that cause the sewing machine to perform the step of receiving a command to change the size of at least one of the first display area and the second display area, and
in a case where the command has been received, the size of the at least one of the first display area and the second display area is changed in accordance with the command.

17. The non-transitory computer-readable medium according to claim 16, wherein
a specific portion is displayed within the second display area on the display portion, the specific portion indicating an operation portion for changing the size of the second display area, and
in a case where an operation command for the specific portion has been received, the size of at least the second display area is changed.

18. The non-transitory computer-readable medium according to claim 17, wherein
the specific portion is a portion that protrudes from the second display area toward the first display area that is adjacent to the second display area.

19. The non-transitory computer-readable medium according to claim 18, wherein the program further comprises instructions that cause the sewing machine to perform the steps of:
causing the display portion to display a direction indicator within the specific portion, the direction indicator indicating a direction in which the size of the second display area can be changed; and
switching, in a case where the size of the second display area has been changed, the direction indicated by the direction indicator to a direction in which the size of the second display area can be changed the next time.

20. The non-transitory computer-readable medium according to claim 15, wherein
the first information includes a plurality of stitch type selection keys that are used for selecting a stitch type to be sewn, and
the second information includes a plurality of types of function keys that are used for making a setting for the stitch type,
